(19) United States
(12) Patent Application Publication
(10) Pub. No.: US 2025/0312723 A1
(43) Pub. Date: Oct. 9, 2025

(54) IMPURITY REMOVAL STRUCTURE AND AIR PURIFIER

(71) Applicant: Shenzhen Beibanqiu Network Technology Co., Ltd., Shenzhen (CN)

(72) Inventors: Jin LI, Shenzhen (CN); Zhihai TANG, Shenzhen (CN); Weiwei XU, Shenzhen (CN)

(73) Assignee: Shenzhen Beibanqiu Network Technology Co., Ltd., Shenzhen (CN)

(21) Appl. No.: 19/242,915

(22) Filed: Jun. 18, 2025

(30) Foreign Application Priority Data
May 28, 2025 (CN) 202521078814.7

(51) Int. Cl. B01D 46/68; B01D 46/00

(52) U.S. Cl. CPC B01D 46/68; B01D 46/0047

(57) ABSTRACT

An impurity removal structure comprises: a roller core, whose outer surface is provided with an adhesion layer; and a roller core fixing seat arranged adjacent to the roller core at a radial direction of the roller core, and rotatably connected to two axial ends of the roller core. The roller core fixing seat includes fixed covers provided on two radial sides of the roller core, a surface of each fixed cover near the roller core is defined as a first surface; the fixed covers, the roller core and the roller core fixing seat surround to form an accommodating chamber for accommodating the contaminants; when the roller core is rotated, the contaminants adhered to the adhesion layer are gathered and accumulated in accommodating chamber. The cleaned filter element is clean without pollutant depositions, and the filtration efficiency is improved, thereby reducing the frequency of the filter element replacement or cleaning.

### RELATED APPLICATIONS

The present patent document claims the benefit of priority to patent application No. 202521078814.7, filed May 28, 2025, and entitled “IMPURITY REMOVAL STRUCTURE AND AIR PURIFIER,” the entire contents of each of which are incorporated herein by reference.

### BACKGROUND

### 1. Technical Field

The present invention relates to the technical field of dust removal devices, and particularly relates to an impurity removal structure and an air purifier incorporating this structure.

### 2. Background Information

An air purifier is a device used for removing common indoor contaminants, which can improve the indoor air quality.

The working principle of the air purifier is described as follows: a fan is arranged between an air inlet and an air outlet, and a filter element is arranged between the fan and the inlet; when the fan operates, air is driven to flow from the air inlet to the air outlet; the air is filtered through the filter element to remove the common contaminants, and thus clean air is discharged.

However, in the existing technology, after the filter element is used for a long time, the contaminants attached to the filter element are deposited, so that the working efficiency of the air purifier is reduced and the energy consumption is increased. Therefore, users need to replace or clean the filter element regularly.

### BRIEF SUMMARY

In order to overcome the shortcomings of the existing technology, the present invention provides an impurity removal structure and an air purifier incorporating this structure, which can reduce the frequency of the filter element replacement.

The first technical solution adopted by the present invention to solve its technical problems is as follows:

An impurity removal structure comprises:
a roller core, wherein an outer surface of the roller core is provided with an adhesion layer for capturing contaminants on a filter element; and
a roller core fixing seat, wherein the roller core fixing seat is arranged adjacent to the roller core at a radial direction of the roller core, and is rotatably connected to both axial ends of the roller core;
wherein the roller core fixing seat further includes fixed covers provided on both radial sides of the roller core, a surface of each fixed cover near the roller core is defined as a first surface; the fixed covers, the roller core and the roller core fixing seat collectively form an accommodating chamber for accommodating the contaminants; when the roller core is rotated, the contaminants adhered to the adhesion layer are gathered and accumulated in accommodating chamber.

The impurity removal structure as described above, the adhesion layer is fabricated from an adhesive fiber cloth, when the roller core is rotated, the adhesive fiber cloth rubs against the first surface, so that the adhered hair is accumulated in the accommodating chamber.

The impurity removal structure as described above, the fixed cover further includes a scraping layer provided on the first surface, the scraping layer is provided with a plurality of first filamentary structures, and the first filamentary structures are arranged toward a direction of the accommodating chamber.

The impurity removal structure as described above, the outer surface of the roller core is provided with a limiting block, and the limiting block is configured to abut against the fixed covers so as to limit a rotational angle of the roller core.

The impurity removal structure as described above, the limiting block is configured as a strip shape and arranged on the roller core in the axial direction of the roller core.

The impurity removal structure as described above, the limiting block is fabricated from an elastic material.

The impurity removal structure as described above,
the adhesion layer includes a first adhesion layer and a second adhesion layer;
the first adhesion layer and the second adhesion layer are respectively arranged on both sides of the limiting block in a radial cross-section of the roller core.

The impurity removal structure as described above, wherein both the first adhesion layer and the second adhesion layer are provided with a plurality of second filamentary structures, extension lines of the second filamentary structure are tangent to a roll diameter of the roll core and oriented away from the roller core in a direction of the limiting block.

The impurity removal structure as described above, a distance between an end of the fixed cover away from the roller core fixing seat and the roller core or the adhesion layer is D, a length of the limiting block beyond an outer surface of the roller core is d, a shortest distance between the fixed cover and the adhesion layer is L, and a relationship between D, d, and L satisfies: D≥d>L.

The second technical solution adopted by the present invention to solve its technical problems is as follows:

An air purifier, comprises:
a housing;
an air outlet, which is arranged on the housing;
an air inlet, which arranged on the housing;
a fan, which is arranged in the housing and used to drive air to flow from the air inlet to the air outlet;
a filter element, which is arranged between the air inlet and the fan and used to filter the air entering the housing through the air inlet, wherein a surface of the filter element adjacent to the air inlet is an impurity accumulation surface;
the impurity removal structure as described above, which is arranged between the filter element and the air inlet; and
a transmission mechanism, which is arranged between the air inlet and the filter element, wherein the transmission mechanism is fixed to the housing, and a movable end of the transmission mechanism is connected to the roller core fixing seat for driving the impurity removal structure to reciprocate on the impurity accumulation surface.

The present invention has the following beneficial effects.
1. The present invention discloses an impurity removal structure, wherein an outer surface of a roller core is provided with an adhesion layer for capturing contaminants on a filter element, a roller core fixing seat is rotatably connected to both axial ends of the roller core, fixed covers are provided on both sides of the roller core at a radial direction of the roller core, and the fixed covers, the roller core, and the roller core fixing seat collectively form an accommodating chamber for accommodating the contaminants. When in use, the adhesion layer is attached to a surface of the filter element to be cleaned, and the roller core fixing seat is pushed to rotate the roller core, so as to drive the adhesion layer to capturing the contaminants on the filter element, and then the roller core fixing seat is pushed continuously in the same direction, the adhered contaminants rotate into the accommodating chamber as the roller core rotates. The cleaned filter element is clean without pollutant depositions, and the filtration efficiency is improved, thereby reducing the frequency of the filter element replacement or cleaning.
2. The present invention further discloses an air purifier, wherein a transmission mechanism is configured to drive the impurity removal structure to reciprocate on an impurity accumulation surface, so as to remove the contaminants on the impurity accumulation surface of the filter element, thereby improving the working efficiency of the air purifier and reducing the energy consumption of the air purifier.

### BRIEF DESCRIPTION OF THE DRAWINGS

The present invention is further illustrated below with reference to the drawings and embodiments.

FIG. 1 is a cross-sectional view of an impurity removal structure in an embodiment of the present invention.

FIG. 2 is a structural enlarged view of part A in FIG. 1.

FIG. 3 is a working state diagram of the impurity removal structure in FIG. 1.

FIG. 4 is another working state diagram of the impurity removal structure in FIG. 1.

FIG. 5 is a cross-sectional diagram of an air purifier in the embodiment of FIG. 1.

FIG. 6 is a schematic structural diagram of the air purifier in the embodiment with partial housing hidden.

The reference numerals are as follows:
housing 1, air outlet 11, air inlet 12, fan 2, filter element 3, impurity accumulation surface 31, impurity removal structure 4, roller core 41, adhesion layer 42, first adhesion layer 421, second adhesion layer 422, roller core fixing seat 43, fixed cover 431, first surface 4311, scraping layer 4312, first scraping layer 4312-1, second scraping layer 4312-2, accommodating chamber 40, limiting block 45, transmission mechanism 5, left screw rod 51, right screw rod 52, right screw rod nut 53, drive motor 55.

### DETAILED DESCRIPTION OF THE DRAWINGS AND THE PRESENTLY PREFERRED EMBODIMENTS

In order to make the objectives, technical solutions, and advantages of the present invention clearer, the present invention is further illustrated hereafter with reference to the accompanying drawings and embodiments. Examples of the embodiments are illustrated in the drawings, wherein the same or similar reference numerals represent the same or similar components or elements with the same or similar functions throughout. The embodiments described below with reference to the drawings are exemplary and are intended only to explain the present invention, and cannot be understood as restrictions on the present invention. In addition, it should be understood that the specific embodiments described herein are merely intended to illustrate the present invention and are not intended to limit the present invention.

In the description of the present invention, it should be understood that, any reference to direction or positional relationship is based on the direction or positional relationship shown in the accompanying drawings. These references are used solely for the purpose of clearly describing the present invention and simplifying the description, and do not indicate or imply that the device or element referred to must have a specific orientation, or be constructed and operated in a specific orientation, and therefore cannot be understood as limiting the scope of the present invention.

In addition, the terms such as “first” and “second” are used merely for the purpose of description, and shall not be construed as indicating or implying relative importance or implying the quantity of indicated technical features. Therefore, a feature defined by “first” or “second” can explicitly or implicitly include one or more of the features. In the description of the present invention, unless otherwise clearly specified, “multiple” means two or more.

The following invention provides various embodiments or examples to achieve different structures of the present invention. To simplify the description, components and configurations of specific examples are described below. Of course, they are only examples and are not intended to limit the scope of the present invention. Furthermore, the present invention can repeat reference numerals and/or reference letters in different examples. Such repetition is for the purpose of simplicity and clarity, and does not imply any specific relationships between the described embodiments and/or configurations. Additionally, the present invention provides examples of specific processes and materials, but those skilled in the art can recognize that alternative processes and/or materials may also be applicable.

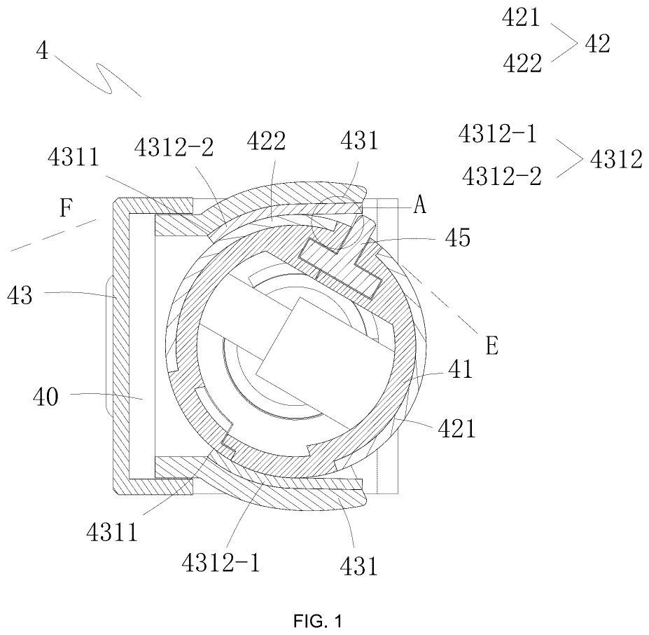

Referring to FIG. 1, an impurity removal structure 4 comprises a roller core 41 and a roller core fixing seat 43, wherein an outer surface of the roller core 41 is provided with an adhesion layer 42, and the adhesion layer 4 is used for capturing contaminants on a filter element. The roller core fixing seat 43 is arranged adjacent to the roller core 41 at a radial direction of the roller core 41, and is rotatably connected to both axial ends of the roller core 41. The roller core fixing seat 43 includes fixed covers 431 provided on both sides of the roller core 41 in the radial direction of the roller core 41. A surface of each fixed cover 431 near the roller core 41 is defined as a first surface 4311. The fixed covers 431, the roller core 41 and the roller core fixing seat 43 collectively form an accommodating chamber 40 for accommodating the contaminants, when the roller core 41 is rotated, the contaminants adhered to the adhesion layer 42 are gathered and accumulated in accommodating chamber 40.

Referring to FIG. 1, a usage of the impurity removal structure 4 is illustrated by example: first, the roller core 41 is abutted against the filter element, so that the adhesion layer is attached to a surface of the filter element 3 to be cleaned. The roller core fixing seat 430 is pushed in direction A, since the roller core fixing seat 43 is rotatably connected to both axial ends of the roller core 41, the roller core 41 and the adhesion layer 42 rotate simultaneously, thus the adhesion layer 42 captures the contaminants on the filter element 3. The roller core fixing seat 43 is pushed continuously in direction A, the adhered contaminants rotate into the accommodating chamber 40 as the roller core 42 rotates. Therefore, the cleaned filter element 3 is clean without pollutant depositions, and the filtration efficiency is improved, thereby reducing the frequency of the filter element replacement or cleaning.

As a preferred embodiment of the present invention, the impurity removal structure 4 can be applied to a pet air purifier. As a filter element in the pet air purifier is used for a long term, a surface of the filter element is easy to adsorb pet hair and dust, and the pet hair can easily clog air inlets on the surface of the filter element, so that the air purification capacity is reduced and users need to frequently remove the hair on the surface of the filter element. In the following section, the use of the impurity removal structure 4 in the pet air purifier will be illustrated as an example.

It is understood that the impurity removal structure 4 is applied to the pet air purifier, the pet hair is accumulated on a surface of the filter element 3, the roller core fixing seat 43 is pushed in direction A, the adhesion layer 42 adheres to the pet hair and takes into the accommodating chamber 40, and the pet hair in the accommodating chamber 40 is in a loose state, and part of the pet hair is in contact with an inner wall of the accommodating chamber 40. Then the roller core fixing seat 43 is pushed continuously, the adhesion layer 42 rubs against the first surface 4311 to scrape off the pet hair adhered to the adhesion layer 42, thus to clean the filter element 3.

Referring to FIG. 1, furthermore, the adhesion layer 42 is fabricated from an adhesive fiber cloth, when the roller core 41 is rotated, the adhesive fiber cloth rubs against the first surface 431, so that the adhered hair is accumulated in the accommodating chamber 40.

The adhesive fiber cloth is a kind of cloth specially used for hair removal, and particularly suitable for a pet air purifier. It can adhere an amount of pet hair at one time, thus to improve cleaning effect.

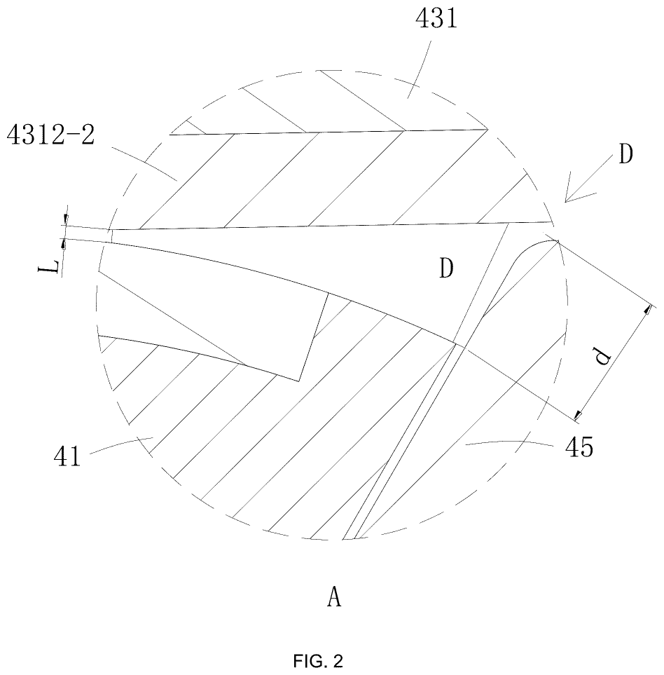

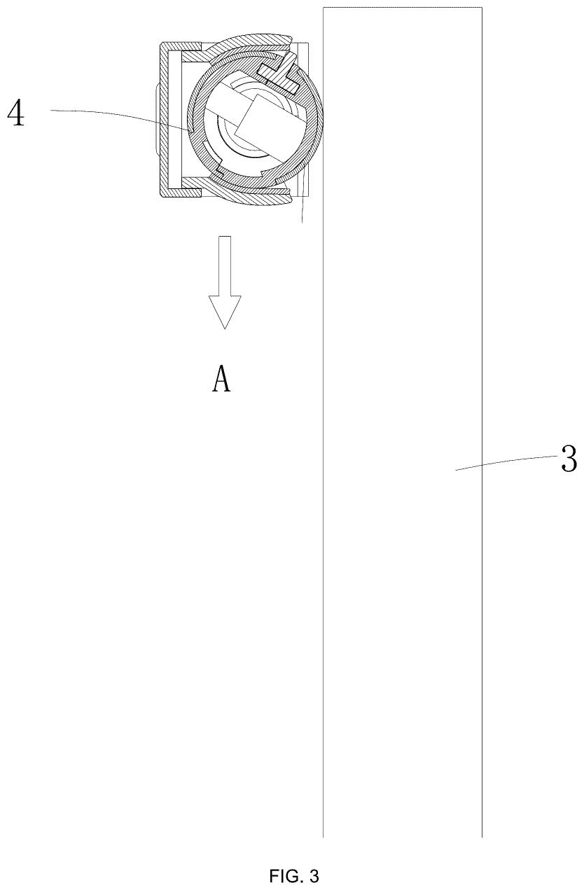

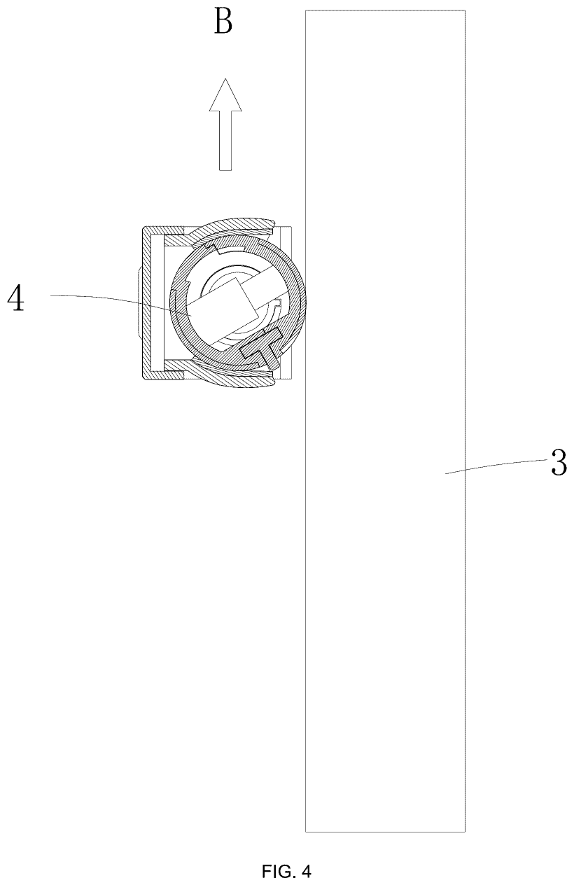

Referring to FIGS. 1-4, furthermore, the fixed cover 431 further includes a scraping layer 4312 arranged on the first surface 4311. The scraping layer 4312 is provided with a plurality of first filamentary structures, and the first filamentary structure is arranged toward a direction of the accommodating chamber 40 (the direction of the first filamentary structure could be referred to arrow orientation indicated in FIG. 2).

It should be understood that, fixed covers 431 are provided on both sides of the roller core 41, and each first surface 4311 is provided with the scraping layer 4312, and the scraping layer 4312 on both sides are named as a first scraping layer 4312-1 and a second scraping layer 4312-2, respectively. The working principle of this embodiment is illustrated by example below: when the roller core 41 rotates clockwise, the adhesion layer 42 together with its adhered hair enters into the accommodating chamber 40 following the orientation of the first filamentary structures of the first scraping layer 4312-1; when the roller core 41 is rotated in an opposite direction, a rotational direction of the roller core 41 is opposite to the orientation of the first filamentary structures, and the first scraping layer 4312-1 scrapes off the hair from the adhesion layer 42 into the accommodating chamber 40, thereby removing the pet hair from the scraping layer 4312. Similarly, when the roller core 41 is rotated counterclockwise, the adhesion layer 42 together with its adhered hair enters into the accommodating chamber 40 following the orientation of the first filamentary structures of the second scraping layer 4312-2; when the roller core 41 is rotated in an opposite direction, and the second scraping layer 4312-2 scrapes off the hair from the adhesion layer 42 into the accommodating chamber 40.

The scraping layer 4312 with the first filamentary structures is configured to enhance the cleanness of the adhesion layer 42, thereby increasing the amount of pet hair adhered from the filter element 3 and improving the cleaning effect of the filter element 3. The first filamentary structures are arranged toward the direction of the accommodating chamber 40 for scraping the pet hair off the adhesion layer 42, which is a means of improving the cleanness of the adhesion layer 42.

As a preferred embodiment, taking a cross-section in the radial direction of the roller core 41, the roller core fixing seat 43 and the fixed cover 431 enclose at least half of an outer periphery of the roller core 41, providing sufficient space to guide the hair of the scraping layer 4312 into the accommodating chamber 40.

In one embodiment, the outer surface of the roller core 41 is provided with a limiting block 45. The limiting block 45 is used to abut against the fixed covers 431, so as to limit a rotational angle of the roller core 41, thereby maintaining a relative position of the adhesion layer 42 and the filter element 3.

It should be understood that, when the roller core fixing seat 43 is pushed toward direction A, the roller core 41 rotates counterclockwise, and the limiting block 45 abuts against one side of the fixed cover 431. The roller core fixing seat 43 is pushed continuously toward the direction A, a relative position of the roller core 41 and the roller core fixing seat 43 is unchanged, and the hair adhered to the first surface 4311 accumulates at an angle between the adhesion layer 42 and the filter element 3. When the roller core fixing seat 43 is pushed toward direction B (direction B is opposite to direction A), the roller core 41 rotates clockwise, the adhesion layer 42 with adhered hair enters into the accommodating chamber 40, and then the roller core fixing seat 43 is pushed toward direction A again, the first scraping layer 4312-1 scrapes off the hair from the adhesion layer 42.

In one embodiment, the limiting block 45 is configured as a strip shape and arranged on the roller core 41 along the axial direction of the roller core 41.

The strip shaped limiting block 45 has more contact points with the fixed cover 431, so that the limiting block 45 more effectively fixes the relative position between the roller core 41 and the roller core fixing seat 43.

In one embodiment, the limiting block 45 is fabricated from an elastic material. When the limiting block 45 comes into contact with the fixed covers 431, the limiting block 45 deforms and absorbs a part of the energy, thereby reducing damages caused by the collision between the limiting block 45 and the fixed covers 431 to the entire impurity removal structure 4, preventing deformation of components within the impurity removal structure 4, thereby maintaining the efficiency of impurity removal.

Referring to FIGS. 1-4, in one embodiment, the adhesion layer 42 includes a first adhesion layer 421 and a second adhesion layer 422.

In a radial section of the roller core 41, the first adhesion layer 421 and the second adhesion layer 422 are arranged on both sides of the limiting block 45, respectively.

It should be understood that, when the roller core fixing seat 43 is pushed in direction A, the roller core 41 rotates counterclockwise by approximately 130 degrees, and the second adhesion layer 422 enters into the accommodating chamber 40 or is adjacent to the second scraping layer 4312-2. Pushing the roller core fixing seat 43 continuously in direction A, the relative position between the roller core 41 and the roller core fixing seat 43 is unchanged, the hair adhered to the first surface 4311 is accumulated at an angle between the first adhesion layer 421 and the filter element 3. When the roller core fixing seat 43 is pushed in direction B, the roller core 41 rotates clockwise, the second adhesion layer 422 abuts against the first surface 4311, and the first adhesion layer 421 with adhered hair enters into the accommodating chamber 40. If residual hair remains on the first surface 4311, the residual hair will be accumulated between the second adhesion layer 422 and the filter element 3 as the roller core fixing seat 43 moves. The roller core fixing seat 43 is pushed in an opposite direction, and the adhered hair on the first adhesion layer 421 is scraped off by the first scraping layer 4312-1 into the accommodating chamber 40. By repeating the above operation, the adhered hair on the second adhesion layer 422 is scraped off by the second scraping layer 4312-2 into the accommodating chamber 40. By repeating this step, the first surface 431 can be cleaned. The process is simple, and since the roller core 41 moves one end, the adhesion layer 42 is cleaned once, the cleaning effect of the filter element 3 is better.

In one embodiment, both the first adhesion layer 421 and the second adhesion layer 422 are provided with a plurality of second filamentary structures, and extension lines of the second filamentary structures are tangent to a roll diameter of the roll core 41 (extension lines of the second filamentary structures of the first adhesion layer 421 are oriented as broken line E as shown in FIG. 1, while that of the second adhesion layer 422 is broken line F) toward a direction away from the roller core 41 along a direction of the limiting block 45. The orientation of the second filamentary structures is an angle that hair is accumulated between the adhesion layer 42 and the filter element 3. Consequently, when the roller core 41 rotates, more hair are taken and rolled into the accommodating chamber 40, thereby further enhancing the cleaning effect of the filter element 3.

Referring to FIG. 2, in one embodiment, a distance between an end of the fixed cover 431 away from the roller core fixing seat 43 and the roller core 41 or the adhesion layer 42 is D, a length of the limiting block 45 beyond an outer surface of the roll core 41 is d, a shortest distance between the fixed cover 431 and the adhesion layer 42 is L. The relationship between D, d, and L satisfies: D≥d>L, which ensures that the limiting block 45 will not enter the accommodating chamber 40, thereby maintaining its function of fixing the relative position between the roller core 41 and the filter element 3.

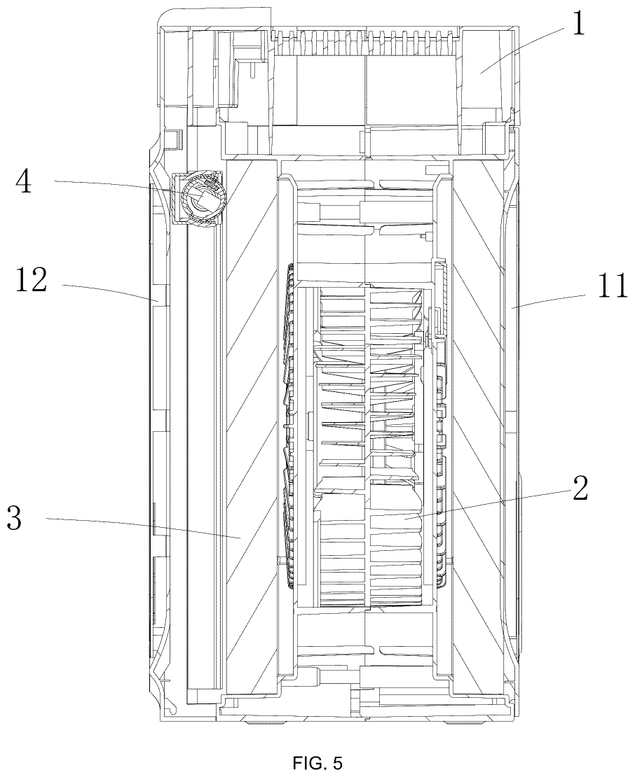

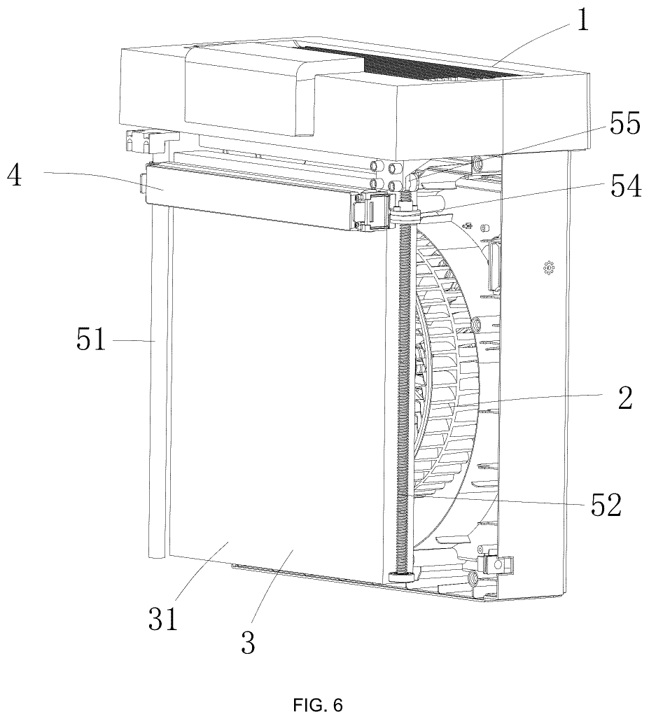

Referring to FIGS. 5-6, as a preferred embodiment, the above impurity removal structure 4 can be applied to an air purifier. The air purifier comprises: a housing 1; an air outlet 11 arranged on the housing 1; an air inlet 12 arranged on the housing 1; a fan 2 arranged in the housing 1 and used to drive air to flow from the air inlet 12 to the air outlet 11; a filter element 3 arranged between the air inlet 12 and the fan 2 for filtering the air entering the housing 1 through the air inlet 12, wherein a surface of the filter element adjacent to the air inlet is an impurity accumulation surface; the impurity removal structure 4 as described in any one of the above embodiments, which is arranged between the filter element 3 and the air inlet 12; and

a transmission mechanism 5 arranged between the air inlet 12 and the filter element 3, wherein the transmission mechanism 5 is fixed to the housing 1, and a movable end of the transmission mechanism 5 is connected to the roller core fixing seat 43 for driving the impurity removal structure 4 to reciprocate on the impurity accumulation surface 31.

The transmission mechanism 5 replaces manual operations with a mechanical transmission to achieve fully automatic removal of the hair attached to the filter element 3, thereby improving the user experiences.

As a preferred embodiment, the transmission mechanism 5 includes a left screw rod 51, a right screw rod 52, a left screw rod nut, a right screw rod nut 54 and a drive motor 55.

The left screw rod 51 and the right screw rod 52 are arranged parallel to each other. Both ends of the left screw rod 51 are rotatably connected to the housing 1; one end of the right screw rod 52 is rotatably connected to the housing, and the other end is drivingly connected to a drive end of the drive motor 55. The left screw rod nut is threadedly connected to the left screw rod 51, and the right screw rod nut 54 is threadedly connected to the right screw rod 52. Along a radial direction of the roller core 41, the left screw rod nut and the right screw rod nut 54 are connected to the roller core fixing seat 43, respectively.

The drive motor 55 drives the right screw rod 52 to rotate, so that the left screw rod nut moves axially along the left screw rod 51 and the right screw rod nut 54 moves along a axial direction of the right screw rod 52, so as to drive the impurity removal structure 4 to remove the impurities accumulated on the impurity accumulation surface 31.

Of course, the left screw rod 51 can also be replaced with a guide rail, and the left screw rod nut can be replaced with a slider.

Specifically, the transmission mechanism 5 can also be configured as a belt transmission mechanism.

The above provides detailed descriptions of preferred embodiments of the present invention. However, the scope of the present invention is not limited to the described embodiments. Those skilled in the art can make various equivalent modifications or substitutions without departing from the spirits of the present invention, and all such equivalent modifications or substitutions shall fall within the scope defined by the claims of the present invention.

1. An impurity removal structure, comprising:
a roller core, whose outer surface is provided with an adhesion layer for capturing contaminants on a filter element; and
a roller core fixing seat, which is arranged adjacent to the roller core at a radial direction of the roller core, and is rotatably connected to the roller core along two axial ends of the roller core,
wherein the roller core fixing seat includes fixed covers configured on two radial sides of the roller core, a surface of each fixed cover near the roller core is defined as a first surface; the fixed covers, the roller core and the roller core fixing seat surround to form an accommodating chamber for accommodating the contaminants; when the roller core is rotated, the contaminants adhered to the adhesion layer are gathered and accumulated in the accommodating chamber.

2. The impurity removal structure according to claim 1, wherein the adhesion layer is made of an adhesive fiber cloth, when the roller core is rotated, the adhesive fiber cloth rubs against the first surface, so that hair adhered on the adhesive fiber cloth is accumulated in the accommodating chamber.

3. The impurity removal structure according to claim 1, wherein the fixed cover further includes a scraping layer provided on the first surface, the scraping layer is provided with a plurality of first filamentary structures, and the first filamentary structures are arranged along a direction toward the accommodating chamber.

4. The impurity removal structure according to claim 3, taking a cross-section in the radial direction of the roller core, the roller core fixing seat and the fixed cover enclose at least half of an outer periphery of the roller core, providing sufficient space to guide the hair of the scraping layer into the accommodating chamber.

5. The impurity removal structure according to claim 3, wherein the outer surface of the roller core is provided with a limiting block, which is configured to abut against the fixed covers, so as to limit a rotational angle of the roller core.

6. The impurity removal structure according to claim 5, wherein the limiting block is configured as a strip shape and arranged on the roller core along the axial direction of the roller core.

7. The impurity removal structure according to claim 5, wherein the limiting block is made of an elastic material.

8. The impurity removal structure according to claim 5, wherein
the adhesion layer includes a first adhesion layer and a second adhesion layer;
the first adhesion layer and the second adhesion layer are respectively arranged on two sides of the limiting block at the radial direction of the roller core.

9. The impurity removal structure according to claim 8, wherein both the first adhesion layer and the second adhesion layer are provided with a plurality of second filamentary structures, extension lines of the second filamentary structure are tangent to a roll diameter of the roll core and oriented away from the roller core in a direction of the limiting block.

10. The impurity removal structure according to claim 3, wherein a distance between an end of the fixed cover away from the roller core fixing seat and the roller core or the adhesion layer is D, a length of the limiting block beyond the outer surface of the roller core is d, a shortest distance between the fixed cover and the adhesion layer is L, and a relationship between D, d, and L satisfies: D≥d>L.

11. An air purifier, comprising:
a housing;
an air outlet, which is arranged on the housing;
an air inlet, which arranged on the housing;
a fan, which is arranged in the housing and used to drive air to flow from the air inlet to the air outlet;
a filter element, which is arranged between the air inlet and the fan and used for filtering air entering the housing through the air inlet, wherein a surface of the filter element adjacent to the air inlet is an impurity accumulation surface;
the impurity removal structure according to claim 1, which is arranged between the filter element and the air inlet; and
a transmission mechanism, which is arranged between the air inlet and the filter element, wherein the transmission mechanism is fixed to the housing, and a movable end of the transmission mechanism is connected to the roller core fixing seat for driving the impurity removal structure to reciprocate on the impurity accumulation surface.

12. The air purifier according to claim 11, wherein the transmission mechanism includes a left screw rod, a right screw rod, a left screw rod nut, a right screw rod nut and a drive motor,
the left screw rod and the right screw rod are arranged parallel to each other, both ends of the left screw rod are rotatably connected to the housing; one end of the right screw rod is rotatably connected to the housing, and the other end is drivingly connected to a drive end of the drive motor, the left screw rod nut is threadedly connected to the left screw rod, and the right screw rod nut is threadedly connected to the right screw rod, along a radial direction of the roller core, the left screw rod nut and the right screw rod nut are connected to the roller core fixing seat, respectively,
the drive motor drives the right screw rod to rotate, so that the left screw rod nut moves axially along the left screw rod and the right screw rod nut moves along an axial direction of the right screw rod, so as to drive the impurity removal structure to remove the impurities accumulated on the impurity accumulation surface.
